(19) United States
(12) Patent Application Publication
(10) Pub. No.: US 2023/0353243 A1
(43) Pub. Date: Nov. 2, 2023

(54) GENERATING A COMMON AND STABLE RADIO FREQUENCY (RF) CARRIER FOR A PLURALITY OF DISTRIBUTED UNITS

(71) Applicant: Telefonaktiebolaget LM Ericsson (publ), Stockholm (SE)

(72) Inventors: Rafael PUERTA, Sundbyberg (SE); Cristian CZEGLEDI, Göteborg (SE); Jonas HANSRYD, Göteborg (SE); Olav QUESETH, Solna (SE)

(73) Assignee: Telefonaktiebolaget LM Ericsson (publ), Stockholm (SE)

(21) Appl. No.: 18/021,800

(22) PCT Filed: Aug. 20, 2020
(86) PCT No.: PCT/EP2020/073440

§ 371 Date: Feb. 16, 2023

(51) Int. Cl. H04B 10/2575; H04J 14/02

(52) U.S. Cl. CPC H04B 10/25753; H04J 14/02; H04B 2210/006

(57) ABSTRACT

A method performed by a CU (202, 302) for enabling at least two DUs, to generate an RF carrier. In one embodiment the method includes the CU using a single light source (212) to generate two or more optical carriers, wherein the generated optical carriers are all phase coherent with one another. The method also includes the CU generating a first single sideband (SSB) signal for a first DU using two of the generated optical carriers and generating a second SSB signal for a second DU using two of the generated optical carriers. The method also includes the CU transmitting the first SSB to the first DU and transmitting the second SSB to the second DU.

### TECHNICAL FIELD

Disclosed are embodiments related to systems and method for generating a common and stable radio frequency (RF) carrier for a plurality of distributed units (DUs).

### BACKGROUND

Microwave backhaul using point-to-point, line-of-sight (LOS) links will in future telecommunication systems have higher demands on data rates to support the increasingly higher mobile data traffic. Multiple-Input-Multiple-Output (MIMO) is a technology that can be used to support this high data-rate demand. MIMO adds new dimensions to increase the spectral efficiency in point-to-point links by utilizing parallel spatial data streams on the same frequency band. In order to maximize performance, for each specific link, there exists an optimal geometric antenna deployment such that the capacity of the link is maximized. This deployment depends on the number of antennas, link separation distance and hop length.

### SUMMARY

Certain challenges presently exist. For instance, in practice it is not always possible to deploy the antennas according to the optimal deployment. For example, in a squared four stream antenna system (i.e., a 4×4 MIMO) the optimum antenna separation is 13 meters (m) if the carrier frequency is 18 GHz and the hop length 20 km, which can be problematic to accommodate for such a deployment. Suboptimal antenna deployments result in a penalty on system gain, throughput, and/or availability. This loss in performance can be reduced by applying a signal processing technique called precoding.

FIG. 1 shows the expected capacity of a dual-polarized 4×4 MIMO link with and without precoding. As can be seen, at low antenna separation (<40% of optimal separation), the capacity obtained with precoding is doubled compared to without precoding. However, in order for precoding to work, the local oscillators (LOs) used for up-conversion to RF of the different MIMO streams must be synchronized, such that the phase noise over the different MIMO streams is correlated to a high degree. The degree of phase noise correlation among the different MIMO streams depends on the link details, such as MIMO order, baud rate, and phase noise strength. The required degree of phase noise correlation increases with the MIMO order and phase noise strength.

Several architectures have been proposed to centralize and synchronize the local oscillators (LOs) of numerous distributed radio units (DUs). In general, a reference signal for synchronization purposes is generated in a central unit (CU) and then transmitted to all DUs.

A typical architecture is as presented in reference [1]. Reference [1] describes that a reference signal is transmitted to the DUs which may be a precise reference clock or may be a signal used directly to generate the RF carrier. In the CU, the reference signal and the transmitted (TX) data signal are generated with different light sources (LSs) or THz frequencies and transmitted together to the DU through a shared or separate fiber link(s). However, the TX data signal that is sent alongside the reference signal is a digital signal (i.e., digitized in-phase (I) and quadrature (Q) samples plus the transmission protocol overhead). Thus, the fiber link(s) spectral efficiency is low, and the complexity of the DU is high since a digital-to-analog conversion must be done to generate the baseband signal and subsequently its up-conversion to RF using the reference signal.

Another common centralized architecture is presented in reference [2]. In the CU, the TX data baseband signal for each DU is upconverted to the RF carrier frequency in the electrical domain using an LO and a mixer. Then the TX analog RF signal is transmitted using a LS to each DU through a fiber link. In this way, only an optical-to-electrical conversion using a photodetector (PD) is needed at the DUs to generate the analog RF signals (i.e., optical heterodyne detection in a PD in the DU). When the analog RF signal for each DU is generated using different LSs and LOs at the CU, the RF carrier frequencies of the DUs are not synchronized, and its phase noises are uncorrelated.

Yet another approach is described in reference [3], where a common subharmonic of the LO is distributed electrically along the baseband signal. However, this method has limitations on the achievable distance from the CU to the DUs. For example, if the DUs are 300 meters away and the subharmonic is at 2.5 GHz, the attenuation over 300 m is −65 dB, which may be prohibitive.

Accordingly, this disclosure proposes embodiments to generate a common and stable radio frequency (RF) carrier for numerous distributed units (DUs). The RF carrier frequencies of all DUs are synchronized and its phase noises are correlated for both TX and receiving (RX).

In one aspect there is provided a method performed by a CU for enabling at least two DUs, to generate an RF carrier. In one embodiment the method includes the CU using a single light source to generate two or more optical carriers, wherein the generated optical carriers are all phase coherent with one another. The method also includes the CU generating a first single sideband (SSB) signal for a first DU using two of the generated optical carriers and generating a second SSB signal for a second DU using two of the generated optical carriers. The method also includes the CU transmitting the first SSB to the first DU and transmitting the second SSB to the second DU.

The embodiments described herein have several advantages over the existing architectures. For example, the synchronized oscillators allow for the use of precoding techniques, which in turn can provide higher capacities for suboptimal MIMO deployments.

As another example, because the phase noise is highly correlated between all streams, the total requirement on the phase noise will be comparable to a standard SISO-link, as opposed to unsynchronized MIMO, which has stringent phase noise requirements as the MIMO order increases.

Further, as compared to reference [3], the distance between the CU and DUs can be much larger since the attenuation over fiber is much lower compared to copper (i.e., ˜0.2 dB/km vs ˜220 dB/km at 2.5 GHz).

In addition to having highly correlated phase noise among all DUs, due to the fact that only a single LS is used to generate the different wavelengths, it is possible to generate ultra-low phase noise microwave carriers which further improves the performance of the system (e.g., for carrier frequencies from 6 to 72 GHz, the phase-noise @10 kHz offset is below −108 dBc/Hz).

Another advantage is that the TX complexity of microwave DUs is significantly reduced because only optical-to-electrical conversion, amplification and filtering is necessary.

Additionally, the embodiments are very flexible because a wide range of microwave, sub-THz and THz carrier frequencies can be achieved using tunable optics and wideband PDs and photomixers (see, e.g., reference [4] and [5]).

The described embodiments, moreover, provide the advantages of the 3GPP functional split option 8 which allows to separate the PHY (physical layer) and the RF analog front-end (AFE) (see reference [6]). Furthermore, the split option 8 disadvantage of requiring a high front haul bandwidth is overcame since the signal transmitted over the fiber is analog and not digital. Separation between RF and PHY (split option 8) enables the following: 1) shared resources facilitating maintenance and enabling network function virtualization (NFV) and software-defined networking (SDN); 2) isolation of the RF components from updates to the PHY, which may improve RF/PHY scalability; 3) reuse of the RF components to serve PHY layers of different radio access technologies (e.g. single-carrier, multi-carrier waveforms); and 4) pooling of PHY resources, which may enable a more cost-efficient dimensioning of the PHY layer.

### BRIEF DESCRIPTION OF THE DRAWINGS

The accompanying drawings, which are incorporated herein and form part of the specification, illustrate various embodiments.

FIG. 1 shows the expected capacity of a dual-polarized 4×4 MIMO link with and without precoding.

FIG. 2 illustrates a system according to a first embodiment.

FIG. 3 illustrates a system according to a second embodiment.

FIG. 4 illustrates a system according to a third embodiment.

FIG. 5A further illustrates a TX unit according to the first embodiment.

FIG. 5B further illustrates a DU according to the first embodiment.

FIG. 6 further illustrates a TX unit according to the first embodiment.

FIG. 7 illustrates a DU according to another embodiment.

FIG. 8 is a flowchart illustrating a process according to some embodiments.

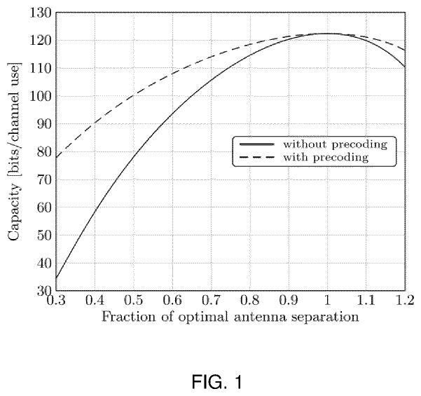

### DETAILED DESCRIPTION

This disclosure proposes embodiments to generate a common and stable radio frequency (RF) carrier for numerous distributed units (DUs). The RF carrier frequencies of all DUs are synchronized and its phase noises are correlated for both TX and receiving (RX).

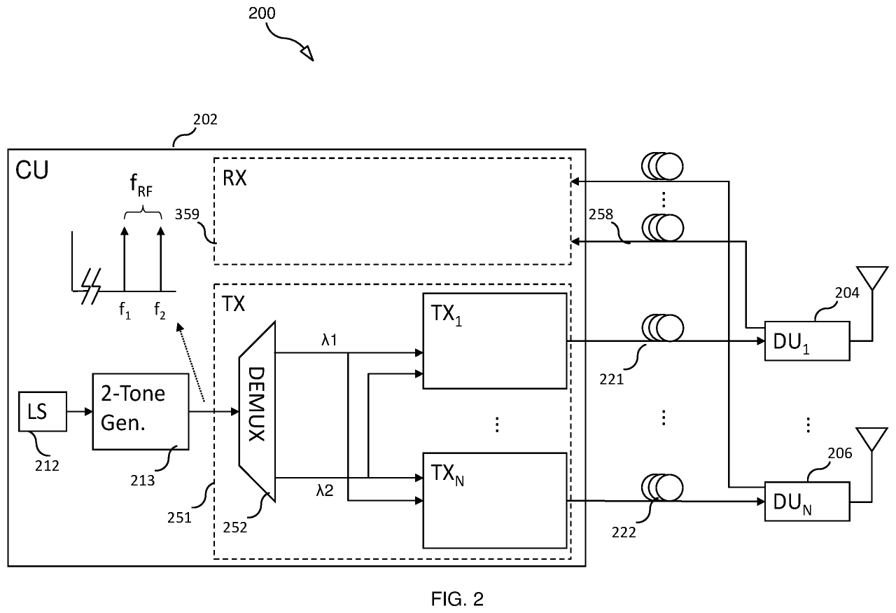

FIG. 2 illustrates a system 200 according to a first embodiment. System 200 includes a CU 202 and multiple DUs (e.g., DU 204 and DU 206) In this embodiment, a single light source (LS) 212 and a 2-tone generator 213 is used to generate two phase coherent optical carriers with a frequency separation (f_{rf}) equal to the RF carrier frequency. These two optical carriers are used by a TX unit 251 to generate at least a first TX radio signal for DU 204 and a second TX radio signal for DU 206 (and any another DUs that are part of the system). The TX radio signals are transmitted to each DU through a separate fiber link. For example, as shown in FIG. 2, the first TX signal for DU 204 is transmitted via fiber link 221 and the second TX signal for DU 206 is transmitted via fiber link 222. At each DU, optical-to-electrical conversion may be accomplished using heterodyne detection in a photodetector (PD) to generate the RF signals for wireless transmission. On the other hand, the received RX radio signals are transmitted to the CU 202 reusing the first optical carrier at each DU, thus all the transmitted RX signals have a highly correlated phase noise as well.

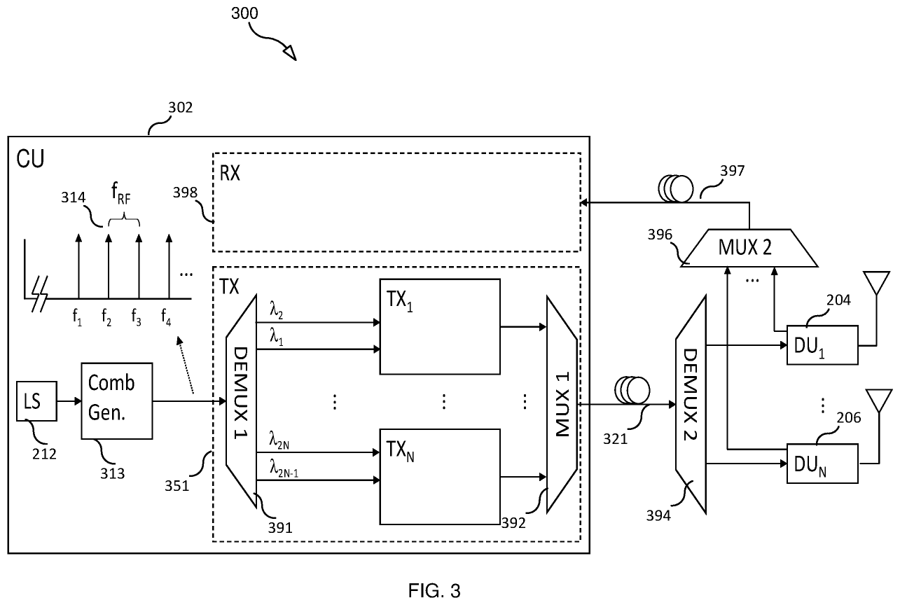

FIG. 3 illustrates a system 300 according to a second embodiment. System 300 includes a CU 302 and multiple DUs (e.g., DU 204 and DU 206). In this embodiment, the LS 212 and a comb generator 313 is used to generate an optical comb 314. All the optical frequency components of the optical comb are harmonically related (i.e., perfectly equidistant in frequency), and all optical frequency components are phase coherent with one another (i.e., share a common phase evolution). The different wavelengths (optical carriers) of the optical comb are demultiplexed and groups of pairs of optical carriers are used by a TX unit 351 to generate the TX radio signal for each DU. Subsequently, all the radio signals are multiplexed through wavelength division multiplexing (WDM) and transmitted to the DUs through a single fiber link 321. At the DUs side, the radio signals are demultiplexed. At each DU optical-to-electrical conversion may be done by means of heterodyne detection in a PD to generate the RF signals for wireless transmission.

The channel spacing of the demultiplexer 391 used to separate the optical comb wavelengths, in some embodiments, is equal to half the channel spacing of the CU multiplexer 392 and the demultiplexer 394 at the DUs side. On the other hand, the received RX radio signals are transmitted to the CU reusing the unmodulated optical carrier at each DU, thus all the RX signals have a highly correlated phase noise as well. Subsequently, all RX signals are multiplexed by WDM multiplexor 396 and transmitted to the CU 302 via link 397 for RX signal processing by RX processing unit 398.

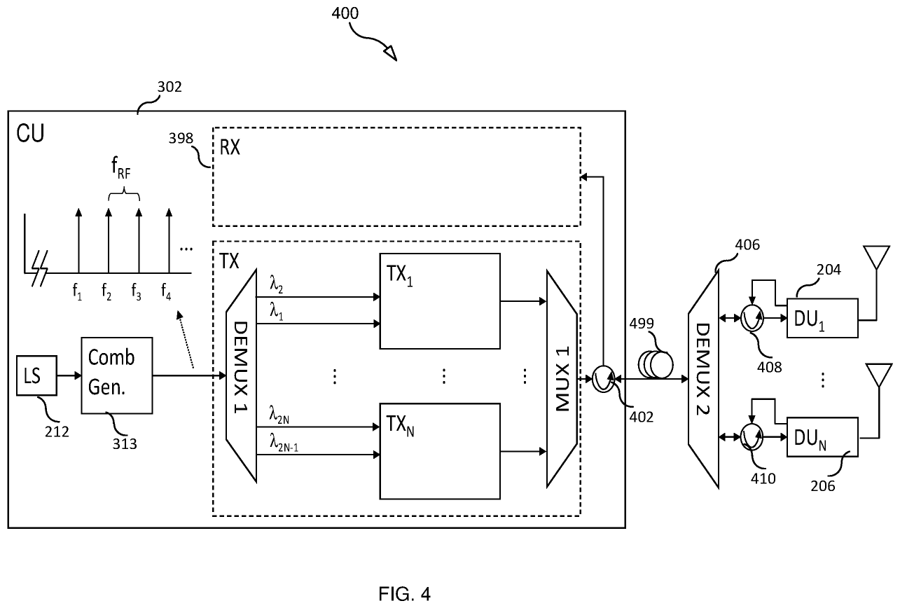

FIG. 4 illustrates a system 400 according to a third embodiment. System 400 includes CU 302 and multiple DUs. In this embodiment the link between CU 302 and the DUs 204 and 206 is a single bi-directional fiber 499. At the CU side, an optical circulator (OCL) 402 is used to separate the incoming signal from the transmitted signal, which propagate in opposite directions in the fiber, for processing by RX unit 398. At the DUs side after demultiplexing by a demultiplexor 406, a set of OCLs (e.g., OCL 408 and OCL 410) are used to send the TX signal to each DU and to couple in the opposite direction the RX signal into the same fiber for subsequent multiplexing. There is an advantage of using only one fiber 499 for both TX and RX, however at the expense of additional hardware per DU and of possibly reducing the performance of the system due to crosstalk between the TX and RX signals (e.g. due to circulator leakage).

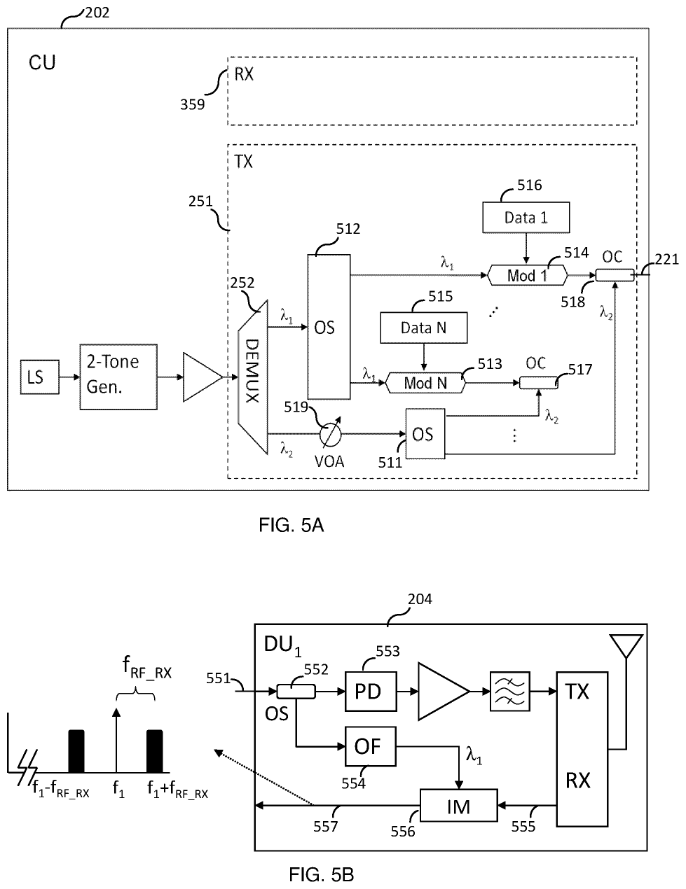

FIG. 5A illustrates TX unit 251 according to an embodiment. Two optical carriers are generated from LS 212. A first optical carrier λ1 having a frequency of f1 and a second optical carrier λ2 having a frequency of f2. These two optical carrier have a frequency separate that is equal to the desired RF carrier frequency f_{rf} (i.e., f_{rf}=|f2−f1|. These two optical carriers are separated via a demultiplexer 252 and then used to generate the TX radio signals for all DUs. A first optical splitter (OS) 511 splits the first optical carrier and a second optical splitter (OS) 512 splits the second optical carrier into as many branches as there are DUs.

The first optical carrier λ1 of each branch is then modulated with an IQ modulator 513 and 514 using the corresponding data 515 and 516 for each DU and subsequently coupled together with the unmodulated second optical carrier λ2 using optical couplers (OCs) 517 and 518. In addition, by means of a variable optical attenuator (VOA) 519, the carrier-to-signal power ratio (CSPR) is adjusted which improves the quality of the signals. The generated single sideband (SSB) radio signals are transmitted to each DU through a separate fiber link.

FIG. 5B illustrates DU 204, according to an embodiment, which is representative of the other DUs. At each DU, an incoming signal (e.g., signal 551) is split into two by an OS 552. The first part is sent to a PD 553 for optical-to-electrical conversion where the beating of λ1 and λ2 generates the TX RF signals (heterodyne detection). The second part is filtered by a narrow optical filter (OF) 554 which filters the modulated optical carrier. Subsequently, λ1 is reused and modulated with a received RX radio signal 555 using an intensity modulator (IM) 556 (e.g. electro-absorption modulator) and then the generated double sideband (DSB) signal 557 is transmitted to the CU 202 through a fiber link 258 (see FIG. 2) for RX signal processing by CU 202. That is CU 202 includes an RX processing unit 359 for processing the signal 557.

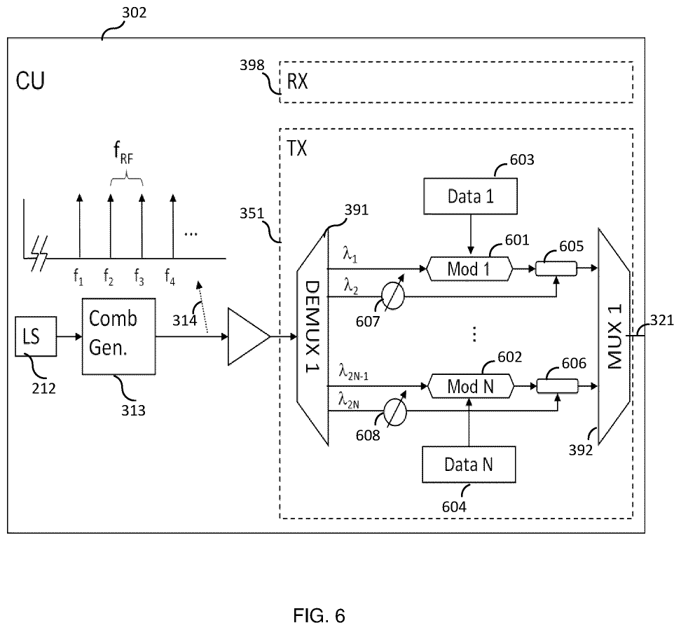

FIG. 6 illustrates TX unit 351 according to an embodiment. As described above with respect to the embodiment shown in FIG. 3, LS 212 and comb generator 313 are used to generate the optical comb 314. In this embodiment, all the optical frequency components of the optical comb have unique characteristics: (1) all frequency components are harmonically related (i.e., perfectly equidistant in frequency) and (2) all frequency components are phase coherent with one another (i.e., share a common phase evolution).

The different wavelengths of the optical comb are demultiplexed using demultiplexer 391 with a channel spacing (bandwidth) equal to B, and groups of pairs of wavelengths are used to generate the TX radio signal for each DU. From each pair, one of the optical carriers is modulated with an IQ modulator using the corresponding data of each DU and then it is coupled with the other optical carrier using an OC. That is, for example, an IQ modulator 601 modulates optical carrier λ1 using data 603 for the first DU (DU 204) and then the resulting modulated signal is coupled with optical carrier λ2 by OC 605; and an IQ modulator 602 modulates optical carrier λN−1 using data 604 for the Nth DU (DU 206) and then the resulting modulated signal is coupled with optical carrier λN by OC 606. In addition, by means of VOAs 607 and 608, the CSPR is adjusted which improves the quality of the signals. Subsequently, all the radio signals are multiplexed through WDM using multiplexer 392 with a channel spacing equal to twice the spacing (2B) of the demultiplexer 391 used with the optical comb, thus both the unmodulated and modulated optical carriers can be placed in a single WDM channel of the multiplexer. Then, all SSB radio signals are transmitted to the DUs through the single fiber link 321.

At the DUs, the radio signals are demultiplexed using demultiplexer 394 with a channel spacing equal to 2B and each demultiplexed WDM channel is transmitted to its corresponding DU. At each DU, the incoming signal is split into two using OS 552. The first part is sent to a PD for optical-to-electrical conversion where the beating between the unmodulated and modulated optical carriers generates the TX RF signals (heterodyne detection). The second part is filtered by OF 554 which filters the modulated optical carrier. Subsequently, the unmodulated optical carrier is reused and modulated with the received RX radio signal using IM 556, thus all the transmitted RX signals have a highly correlated phase noise as well. Subsequently, all RX signals are multiplexed through WDM using multiplexer 396 with a channel spacing equal to 2B and transmitted to the CU through fiber link 397 for RX signal processing by RX unit 398. It is to be noted that the left sideband of the DSB RX signal of each DU is filtered by the multiplexer-filtering action before transmission to the CU.

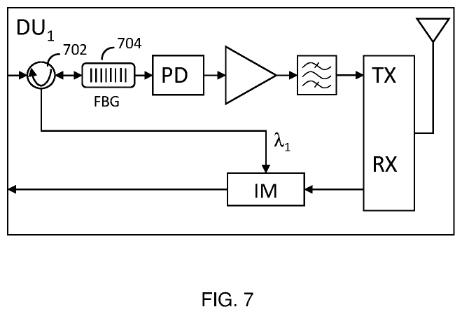

FIG. 7 illustrates an alternative DU arrangement that does not employ OS 552 or OF 554. Instead, to separate the unmodulated optical carrier, an OCL 702 and a temperature insensitive fiber Bragg grating (FBG) 704 are used to reflect the unmodulated optical carrier as show in FIG. 7.

Furthermore, with current dense-WDM (DWDM) technology, as many as 128 WDM channel are available per multiplexer/demultiplexer, being able to serve as many as 64 DUs per fiber. Additionally, DWDM multiplexers/demultiplexers are available with channel spacings as low as 12.5 GHz and as high as 800 GHz which can be used to multiplex/demultiplex microwave carriers from 10 GHz up to 400 GHz (see reference [7]).

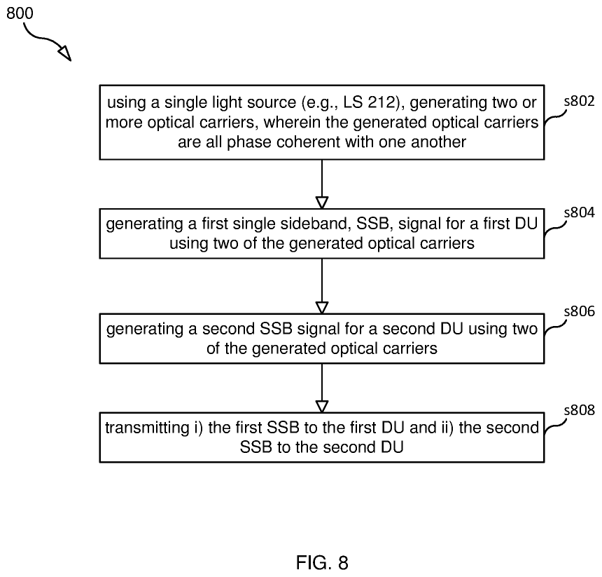

FIG. 8 is a flowchart illustrating a process 800 that is performed by a CU (e.g., CU 202 or CU 302), for enabling at least two DUs (e.g., DU 204 and DU 206) to generate an RF carrier. Process 800 may begin in step s802.

Step s802 comprises the CU using a single light source (e.g., LS 212), generating two or more optical carriers, wherein the generated optical carriers are all phase coherent with one another.

Step s804 comprises the CU generating a first single sideband, SSB, signal for a first DU using two of the generated optical carriers.

Step s806 comprises the CU generating a second SSB signal for a second DU using two of the generated optical carriers.

Step s808 comprises the CU transmitting i) the first SSB to the first DU and ii) the second SSB to the second DU.

In some embodiments, generating the two or more optical carriers using the single light source comprises generating a first optical carrier (e.g., λ2) and a second optical carrier (e.g., λ1) using the single light source, wherein the frequency of the RF carrier is equal to the frequency separation between the first optical carrier and the second optical carrier (i.e., fRF=═f1−f2|, where f1 is the frequency of λ1 and f2 is the frequency of λ2). In such an embodiment, generating the first SSB signal for the first DU comprises generating the first SSB signal using the first optical carrier and the second optical carrier, and generating the second SSB signal for the second DU comprises generating the second SSB signal using the first optical carrier and the second optical carrier. In some embodiments, only the first and second optical carriers are generated using the single light source and an optical splitter is used to distribute the optical carriers within the CU to generate the first and second SSB signals.

In some embodiments, generating the first SSB signal using the first and second optical carriers comprises: employing a first modulator (e.g., modulator 513) to modulate the first optical carrier using data for the first DU, thereby generating a first modulated optical carrier, and combining the first modulated optical carrier with the second optical carrier, and generating the second SSB signal using the first optical carrier and the second optical carrier comprises: employing a second modulator (e.g., modulator 514) to modulate the first optical carrier using data for the second DU, thereby generating a second modulated optical carrier, and combining the second modulated optical carrier with the second optical carrier.

In some embodiments, transmitting the first SSB signal to the first DU and transmitting the second SSB signal to the second DU comprises: transmitting the first SSB signal to the first DU using a first optical fiber link (e.g., link 221) and transmitting the second SSB signal to the second DU using a second optical fiber link (e.g., link 222).

In some embodiments, generating the two or more optical carriers using the single light source comprises: generating an optical comb (e.g., comb 314) comprising at least i) a first optical carrier pair (e.g., λ1 and 2) comprising a first optical carrier (e.g., λ1) and a second optical carrier (e.g., 2) and ii) a second optical carrier pair (e.g., λN−1 and N) comprising a third optical carrier (e.g., λN−1) and a fourth optical carrier (e.g., λN). In such an embodiment, generating the first SSB signal for the first DU comprises generating the first SSB signal using the first optical carrier and the second optical carrier, and generating the second SSB signal for the second DU comprises generating the second SSB signal using the third optical carrier and the fourth optical carrier.

In some embodiments, generating the first SSB signal using the first optical carrier and the second optical carrier comprises: employing a first modulator to modulate the first optical carrier using data for the first DU, thereby generating a first modulated optical carrier, and combining the first modulated optical carrier with the second optical carrier, and generating the second SSB signal using the third optical carrier and the fourth optical carrier comprises: employing a second modulator to modulate the third optical carrier using data for the second DU, thereby generating a second modulated optical carrier; and combining the second modulated optical carrier with the fourth optical carrier.

In some embodiments, transmitting the first SSB signal to the first DU and transmitting the second SSB signal to the second DU comprises: employing a wavelength division multiplexor to produce a multiplexed signal that comprises the first SSB signal and the second SSB signal; and transmitting, via a single optic fiber link 321/499, the multiplexed signal to a demultiplexor (e.g., demultiplexor 394) optically coupled to the first DU and the second DU. In some embodiments, process 800 further includes receiving, via the single optical fiber link, a signal transmitted by the first DU or the second DU. In some embodiments, optical circulator 402 is used to enable the CU 302 to receive the signal via the optical fiber link 499.

In some embodiments, the first DU is configured to obtain the second optical carrier from the first SSB signal, wherein the obtained second optical carrier is an unmodulated optical carrier, and use the obtained second optical carrier to transmit a first RX signal to the CU, and the second DU is configured to obtain the second optical carrier from the second SSB signal and use the obtained second optical carrier to transmit a second RX signal to the CU.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

### Abbreviations

AFE Analog Front-end
C-RAN Cloud/Centralized Radio Access Network
CSPR Carrier-to-signal Power Ratio
CU Central Unit
DSB Double Sideband
DU Distributed Unit
DWDM Dense Wavelength Division Multiplexing
FR Frequency Range
I In-Phase
IM Intensity Modulator
LO Local Oscillator
LS Light Source
MIMO Multiple-input Multiple-output
NFV Network Function Virtualization
OC Optical Coupler
OCL Optical Circulator
OF Optical Filter
OS Optical Splitter
PD Photodetector
PHY Physical Layer
Q Quadrature
RF Radio Frequency
RX Receiver
SSB Single Sideband
TX Transmitter
SDN Software-defined networking
VOA Variable Optical Attenuator
WDM Wavelength Division Multiplexing

### REFERENCES

[1] Hans-Peter Mayer, Heinz Schlesinger, “Antenna synchronization for coherent network MIMO”, EP2590343B1, 20017.
[2] Fan Yu, Jun Zhao, “Optical line terminal, passive optical network and radio frequency signal transmission method”, US20100142955A1, 2010.
[3] M. Horberg, C. Czegledi, J. Sandgren, “Efficient LO-distribution in multi-stream Microwave radio links” P80064, in the process.
[4] Ishizawa, A., Nishikawa, T., Goto, T. et al. Ultralow-phase-noise millimetre-wave signal generator assisted with an electro-optics-modulator-based optical frequency comb. Sci Rep 6, 24621 (2016). https://doi.org/10.1038/srep24621
[5] Fortier, T., Baumann, E. 20 years of developments in optical frequency comb technology and applications. Commun Phys 2, 153 (2019). https://doi.org/10.1038/s42005-019-0249-y
[6] 3GPP, TR 38.801 Radio Access Architecture and Interfaces Release 14.
[7] https://www.ntt-electronics.com/product/photonics/awg_mul_d.html.

1. A method performed by a central unit, CU, (CU) for enabling at least two distributed radio units, DUs, (DUs) to generate a radio frequency (RF) carrier, the method comprising:
using a single light source, generating two or more optical carriers, wherein the generated optical carriers are all phase coherent with one another;
generating a first single sideband, (SSB) signal for a first DU using any two of the generated optical carriers;
generating a second SSB signal for a second DU using any two of the generated optical carriers;
transmitting the first SSB to the first DU; and
transmitting the second SSB to the second DU.

2. The method of claim 1, wherein
generating the two or more optical carriers using the single light source comprises generating a first optical carrier and a second optical carrier using the single light source, wherein the frequency of the RF carrier is equal to the frequency separation between the first optical carrier and the second optical carrier,
generating the first SSB signal for the first DU comprises generating the first SSB signal using the first optical carrier and the second optical carrier, and
generating the second SSB signal for the second DU comprises generating the second SSB signal using the first optical carrier and the second optical carrier.

3. The method of claim 2, wherein only the first and second optical carriers are generated using the single light source and an optical splitter is used to distribute the optical carriers within the CU to generate the first and second SSB signals.

4. The method of claim 2, wherein
generating the first SSB signal using the first optical carrier and the second optical carrier comprises: employing a first modulator to modulate the first optical carrier using data for the first DU, thereby generating a first modulated optical carrier, and combining the first modulated optical carrier with the second optical carrier, and
generating the second SSB signal using the first optical carrier and the second optical carrier comprises: employing a second modulator to modulate the first optical carrier using data for the second DU, thereby generating a second modulated optical carrier, and combining the second modulated optical carrier with the second optical carrier.

5. The method of claim 1, wherein transmitting the first SSB signal to the first DU and transmitting the second SSB signal to the second DU comprises:
transmitting the first SSB signal to the first DU using a first optical fiber link; and
transmitting the second SSB signal to the second DU using a second optical fiber link.

6. The method of claim 1, wherein
generating the two or more optical carriers using the single light source comprises: generating an optical comb comprising at least i) a first optical carrier pair comprising a first optical carrier and a second optical carrier and ii) a second optical carrier pair comprising a third optical carrier and a fourth optical carrier,
generating the first SSB signal for the first DU comprises generating the first SSB signal using the first optical carrier and the second optical carrier, and
generating the second SSB signal for the second DU comprises generating the second SSB signal using the third optical carrier and the fourth optical carrier.

7. The method of claim 6, wherein
generating the first SSB signal using the first optical carrier and the second optical carrier comprises: employing a first modulator to modulate the first optical carrier using data for the first DU, thereby generating a first modulated optical carrier, and combining the first modulated optical carrier with the second optical carrier, and
generating the second SSB signal using the third optical carrier and the fourth optical carrier comprises: employing a second modulator to modulate the third optical carrier using data for the second DU, thereby generating a second modulated optical carrier; and combining the second modulated optical carrier with the fourth optical carrier.

8. The method of claim 6, wherein transmitting the first SSB signal to the first DU and transmitting the second SSB signal to the second DU comprises:
employing a wavelength division multiplexor to produce a multiplexed signal that comprises the first SSB signal and the second SSB signal; and
transmitting, via a single optical fiber link, the multiplexed signal to a demultiplexor optically coupled to the first DU and the second DU.

9. The method of claim 8, wherein
the single optical fiber link is a bi-directional optical fiber link, and
the method further comprises receiving, via the bi-directional optical fiber link, a signal transmitted by the first DU or the second DU.

10. The method of claim 9, wherein an optical circulator is used to enable the CU to receive the signal via the bi-directional optical fiber link.

11. The method of claim 1, wherein
the first DU is configured to obtain the second optical carrier from the first SSB signal, wherein the obtained second optical carrier is an unmodulated optical carrier, and use the obtained second optical carrier to transmit a first RX signal to the CU, and
the second DU is configured to obtain the second optical carrier from the second SSB signal and use the obtained second optical carrier to transmit a second RX signal to the CU.

12. A central unit (CU) for enabling at least two distributed radio units (DUs) to generate a radio frequency (RF) carrier, the CU comprising:
optical carrier generating means for generating two or more optical carriers, wherein the generated optical carriers are all phase coherent with one another, and the optical carrier generating means comprises a single light source;
first single sideband, (SSB) generating means for generating a first SSB signal for a first DU using two of the generated optical carriers;
second SSB generating means for generating a second SSB signal for a second DU using two of the generated optical carriers; and
transmitting means for transmitting i) the first SSB to the first DU and ii) the second SSB to the second DU.

13. The CU of claim 12, wherein
the CU is configured to generate the two or more optical carriers using the single light source by performing a process that includes generating a first optical carrier and a second optical carrier using the single light source, wherein the frequency of the RF carrier is equal to the frequency separation between the first optical carrier and the second optical carrier,
the CU is configured to generate the first SSB signal for the first DU by generating the first SSB signal using the first optical carrier and the second optical carrier, and
the CU is configured to generate the second SSB signal for the second DU by generating the second SSB signal using the first optical carrier and the second optical carrier.

14. The CU of claim 13, further comprising an optical splitter for distributing the optical carriers within the CU to generate the first and second SSB signals.

15. The CU of claim 13, wherein
the CU is configured to generate the first SSB signal using the first optical carrier and the second optical carrier by performing a process that comprises: employing a first modulator to modulate the first optical carrier using data for the first DU, thereby generating a first modulated optical carrier, and combining the first modulated optical carrier with the second optical carrier, and
the CU is configured to generate the second SSB signal using the first optical carrier and the second optical carrier by performing a process that comprises: employing a second modulator to modulate the first optical carrier using data for the second DU, thereby generating a second modulated optical carrier, and combining the second modulated optical carrier with the second optical carrier.

16. The method of claim 12, wherein the transmitting means comprises:
a first optical fiber link for carrying the first SSB signal to the first DU; and
a second optical fiber link for carrying the second SSB signal to the second DU.

17. The CU of claim 12, wherein
the optical carrier generating means comprises the single light source and a comb generator and the optical carrier generating means is configured to generate an optical comb comprising at least i) a first optical carrier pair comprising a first optical carrier and a second optical carrier and ii) a second optical carrier pair comprising a third optical carrier and a fourth optical carriers),
the first SSB generating means is configured to generate the first SSB signal for the first DU using the first optical carrier and the second optical carrier, and
the second SSB generating means is configured to generate the second SSB signal for the second DU sing the third optical carrier and the fourth optical carrier.

18. The CU of claim 17, wherein
the first SSB generating means comprises a first modulator to modulate the first optical carrier using data for the first DU, thereby generating a first modulated optical carrier, and a first optical coupler for combining the first modulated optical carrier with the second optical carrier, and
the second SSB generating means comprises a second modulator to modulate the third optical carrier using data for the second DU, thereby generating a second modulated optical carrier, and a second optical coupler for combining the second modulated optical carrier with the fourth optical carrier.

19. The CU of claim 17, wherein the transmitting means comprises a wavelength division multiplexor for producing a multiplexed signal that comprises the first SSB signal and the second SSB signal; and
a single optical fiber link for carrying the multiplexed signal to a demultiplexor optically coupled to the first DU and the second DU.

20. The CU of claim 19, wherein
the single optical fiber link is a bi-directional optical fiber link, and
the CU further comprises an optical circulator for enabling the CU to receive a via the bi-directional optical fiber link a signal transmitted by the first DU or the second DU.
